(19) United States
(12) Patent Application Publication
(10) Pub. No.: US 2007/0082525 A1
(43) Pub. Date: Apr. 12, 2007

(54) Drinking vessels

(75) Inventor: Michael J. Whidden, Brooklyn, NY (US)

Correspondence Address: PATRICIA A. WENGER, 201 NORTH JACKSON STREET, MEDIA, PA, 19063, US

(73) Assignee: Y Products, LLC

(21) Appl. No.: 11/359,218

(22) Filed: Feb. 21, 2006

Related U.S. Application Data
(60) Provisional application No. 60/724,556, filed on Oct. 8, 2005.

(51) Int. Cl. H01R 29/00

(52) U.S. Cl. 439/188

(57) ABSTRACT

The invention includes embodiments of a device having two or three receptacles for holding liquids for drinking by a user. The receptacles are fixated in relation to each other such that a user can drink all, or substantially all, of the liquid in one of the receptacles without spilling liquid in the other receptacle or receptacles, which can be filled to a specific level. The receptacles are fixated in relation to each other based on formulae that include variables including receptacle angles, spill angles, fill-lines and/or lip angles. The receptacles may be attached to the rest of the device by stems, their outer portions or the may be embedded in a block. The receptacles may include reservoirs into which the liquid may flow.

### REFERENCE TO RELATED APPLICATION

This application claims the benefit of U.S. Provisional Application Ser. No. 60/724,556, filed on Oct. 8, 2005, entitled “Drinking Vessels” of Michael J. Whidden.

### BACKGROUND OF THE INVENTION

Drinking vessels containing two or three receptacles are fixated in a novel manner whereby the user may drink all, or substantially all, of the liquid from any one of the receptacles without spilling the contents of the other receptacles, which may be filled up to a specific fill-line.

### SUMMARY OF THE INVENTION

The invention includes a device for holding liquids for drinking by a user. The device includes two receptacles. Each receptacle further includes a receptacle angle, a resting position, a lead point and a one-sixth point, whereby the receptacle angle includes the angle formed between a line projected between the one-sixth point and the lead point and a line projected upward vertically from the one-sixth point when the device is in a resting position. Each receptacle further includes a spill angle, a fill-line and a lead side. The lead side and the fill-line intersect at an intersection point. Each receptacle further includes a back side and a lip portion, the lip portion further having a back point, whereby the spill angle includes the angle formed between a line projected horizontally across the fill-line from the intersection point toward the back side and a line projected from the intersection point toward the back point when the receptacle is in the resting position. Each receptacle further includes a lip angle. The lip angle includes the angle from horizontal of a line projected from the lead point to the back point when the receptacle is in a resting position.

In one embodiment, each lip angle of each of the two receptacles is greater than or equal to its respective receptacle angle. Each receptacle is fixated in mutual relationship with the other receptacle whereby, in one of the two receptacles, 90 degrees minus the receptacle angle is equal to or less than, in the other one of the two receptacles, the spill angle plus the receptacle angle.

In one embodiment, each lip angle of each of the two receptacles is less than its respective receptacle angle. Each receptacle is fixated in mutual relationship with the other receptacle whereby, in one of the two receptacles, 90 degrees minus the receptacle angle is equal to or less than, in the other one of the two receptacles, two times the spill angle.

In another embodiment, the lip angle of a first receptacle is greater than or equal to its respective receptacle angle and the lip angle of a second receptacle is less than its respective receptacle angle. The first receptacle is fixated in mutual relationship with the second receptacle whereby, in the second receptacle, 90 degrees minus the receptacle angle is equal to or less than, in the first receptacle, the spill angle from horizontal plus the receptacle angle from vertical. Also, the second receptacle is fixated in mutual relationship with the first receptacle whereby, in the first receptacle, 90 degrees minus the receptacle angle is equal to or less than, in the second receptacle, two times the spill angle.

The invention also includes a device for holding liquids for drinking by a user that includes three receptacles, each of the receptacles being non-contiguous with the other two receptacles. Each receptacle has a receptacle angle being generally 45 degrees from vertical. Each receptacle further has a lip portion that has a lead point. The device further has a resting position. Each receptacle is affixed in mutual relationship with each other whereby when the device is in the resting position, when each lead point is projected along a horizontal plane, each projected lead point is generally 120 degrees from each other projected lead point.

The invention further includes a device for holding liquids for drinking by a user that has at least one receptacle. The receptacle has at least one side portion that has a reservoir area.

### BRIEF DESCRIPTION OF THE DRAWINGS

The accompanying drawings, which are incorporated in and form a part of the specification, illustrate the embodiments of the present invention and, together with the description, serve to explain the principles of the invention.

FIG. 1 is a perspective view of an embodiment of the invention having two receptacles.

FIG. 2 is a perspective view of an embodiment of the invention having two receptacles.

FIG. 3 is a perspective view of an embodiment of the invention having three receptacles.

FIG. 4 is a rotated side view of an embodiment of the invention having two receptacles.

FIG. 5 is a rotated side view of an embodiment of the invention having two receptacles.

FIG. 6 is a side view of an embodiment of the invention having two receptacles.

FIG. 7 is a side view of an embodiment of the invention having two receptacles.

FIG. 8 is a side view of an embodiment of the invention having two receptacles.

FIG. 9 is a top view of an embodiment of the invention having two receptacles.

FIG. 10 is a rotated side view of an embodiment of the invention having two receptacles.

FIG. 11 is a side view of an embodiment of the invention having two receptacles.

FIG. 12 is a top view of an embodiment of the invention having two receptacles.

FIG. 13 is a rotated side view of an embodiment of the invention having two receptacles.

FIG. 13a is a side view of an embodiment of the invention having two receptacles.

14A is a perspective view of an embodiment of the invention having two receptacles.

FIGS. 14b-e are side views of embodiments of the invention having two receptacles.

FIGS. 15-21 are partial side views of embodiments of the invention.

FIG. 22 is a partial perspective view of an embodiment of the invention.

FIG. 22a is a view of an open portion of an embodiment of the invention.

FIG. 23 is a partial perspective view of an embodiment of the invention.

FIG. 23a-29 are views of an open portions of embodiments of the invention.

FIG. 30 is a top view of an embodiment of the invention having non-circular receptacles.

FIG. 30a is a side view of an embodiment of the invention having non-circular receptacles.

FIG. 31 is a top view of an embodiment of the invention having two receptacles.

FIGS. 32-33a are top views of embodiments of the invention having three receptacles.

FIGS. 34-36 are top views of embodiments of the invention having two receptacles.

FIGS. 37-43 are side views of embodiments of the invention.

FIG. 44 is a top view of an embodiment of the invention having two receptacles.

FIG. 45 is a top view of an embodiment of the invention having three receptacles.

FIG. 46 is a cross-section view of an embodiment of the invention having receptacles in a block.

FIG. 47 is a top view of an embodiment of the invention having receptacles in a block.

FIG. 48 is a cross-section view of an embodiment of the invention having receptacles in a block.

FIG. 49 is a top view of an embodiment of the invention having receptacles in a block.

FIGS. 50-59 are side views of embodiments of the invention having two receptacles.

FIGS. 60-61a are side views of embodiments of the invention having reservoirs.

FIGS. 62-63 are side views of embodiments of the invention not having reservoirs that show a comparison with FIGS. 64-67 which are side views of embodiments of the invention having reservoirs.

FIGS. 64-67 are side views of embodiments of the invention having reservoirs that show a comparison with FIGS. 62-63 which are side views of embodiments of the invention not having reservoirs.

FIGS. 68-69 are side views of embodiments of the invention having reservoirs.

FIG. 70 is a top view of an embodiment of the invention having reservoirs.

### DETAILED DESCRIPTION OF THE PREFERRED EMBODIMENTS

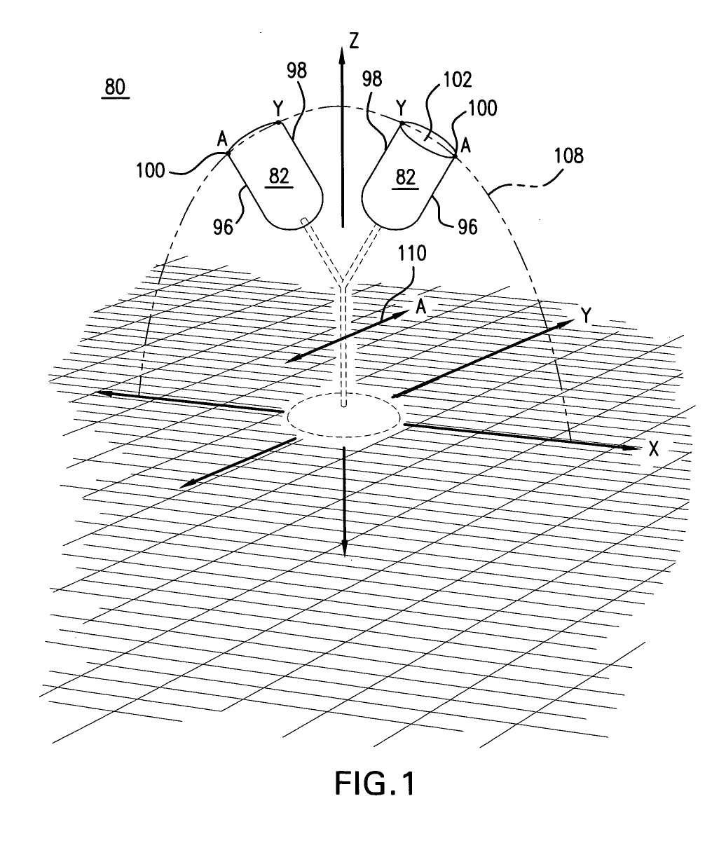

Reference is made to FIGS. 1 through 70 wherein embodiments of a device 80, 80a for holding liquids 112 for drinking by a user are illustrated. It is to be understood that the drawings are not exactly to scale.

Embodiments of the device 80, 80a include two receptacles 82 that are non-contiguous with each other and three receptacles 82 that are non-contiguous with each other. By being non-contiguous it is intended that the liquids 112 in either of the two or three receptacles 82 are not readily able to flow from one receptacle 82 to the other. The receptacles 82 are affixed on the device 80 in mutual relationship with one another whereby each of the receptacles 82 can be filled with liquid 112 to a fill level, referred to as a fill-line 84, and the drinker can drink all, or substantially all, of the liquid 112 from any receptacle 82 without spilling the contents of the other receptacle 82 or receptacles 82. It is also to be noted that the receptacles 82 can be identical to one another or different from one another. Further, it is to be understood that the receptacles 82 of the invention may be permanently or removably affixed to each other and/or the device 80. However, it is desired that if the receptacles 82 are removably attached to each other and/or the device 80, 80a, when the user drinks from the device 80, 80a, the receptacles 82 function as though they are permanently affixed. It is also to be noted that it is intended that the user may drink from a receptacle 82 without the assistance of a drinking straw or any other similar device. The beverages contained by the receptacles 82 may include any drinks that may be consumed. The material, and/or combination of materials, of the device 80 may be any that is, or are, currently known or to be discovered to make a drinking receptacle 82 for drinking any liquid 112.

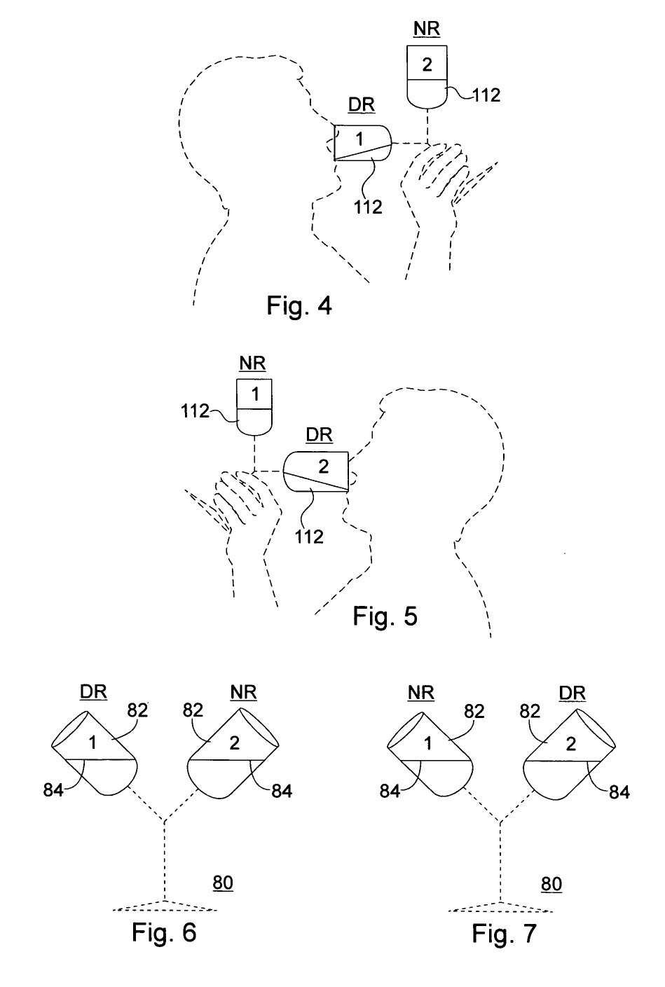

Reference is now specifically made to FIGS. 4-13 illustrating devices 80 having two receptacles 82. As specifically illustrated in FIGS. 4-13, the receptacles 82 are designated as drinking receptacles 82 (“DR”) and non-drinking receptacles 82 (“NR”) for explanatory purposes only. In addition, as seen in these Figures for purposes of explanation only, the receptacles 82 are designated as a first receptacle 82, labeled “1” and a second receptacle 82, labeled “2”. For explanatory purposes only, as seen in the Figures, the same receptacles 82 remain designated respectively as receptacle 1 and receptacle 2, however, the designation of DR and NR may change.

As further illustrated in these Figures, each receptacle 82 is both a DR and a NR because the device 80 is intended to be used such that a user could drink the entire contents, or substantially all of the contents, from either receptacle 82 first without spilling the liquid 112, which is fillable up to a fill-line 84, in the other receptacle 82. A receptacle 82 may be designated as a DR when it is the receptacle 82 from which the user is drinking, intending to drink, intended to drink, or from which a user (a) could drink the entire, or substantially all of the, contents first without spilling the liquid 112 filled up to the fill-line 84 in the other receptacle 82, or (b) to which a calculation is being applied to determine if the user could drink the entire, or substantially all of the, contents first without spilling the liquid 112 filled up to the fill-line 84 in the other receptacle 82. When one receptacle 82 is designated as a DR, the other receptacle 82 in the device 80 designated as the NR. However, it is again to be noted that the device 80 is intended that each receptacle 82 may function both as a DR and a NR.

For example, utilizing these designations for explanatory purposes, in conjunction with FIGS. 4-13, it can be seen that in FIG. 4 the user is drinking from receptacle 1, which is designated as the DR and receptacle 2 is designated as the NR. Then, in FIG. 5, the user is drinking from receptacle 2, and receptacle 2 is designated as the DR, while receptacle 1 is designated as the NR. These Figures illustrate that the device 80 intends to function such that the user could drink the entire contents, or substantially all of the contents, from either receptacle 1 or receptacle 2 first without spilling the contents of the other receptacle 82.

Affixing the receptacles 82 in mutual relationship with one another is based upon two formulae, incorporating receptacle angles 86 (RA), spill angles 88 (SA) and lip angles 90 (LA), which are described in more detail herein. Initially, a lip angle 90 from horizontal and a receptacle angle 86 from vertical must be determined for the NR. If the lip angle 90 of the NR is greater than or equal to the receptacle angle 86 of the NR, the formula to determine the mutual relationships of the receptacles 82 is: 90° minus the receptacle angle of the DR is less than or equal to the spill angle of the NR plus the receptacle angle of the NR.

If the lip angle 90 of the NR is less than the receptacle angle 86 of the NR, the formula to determine the mutual relationships of the receptacles 82 is as follows: 90° minus the receptacle angle of the DR is less than 2 times the spill angle of the NR.

It is preferred that the receptacle angle 86 of either the NR or the DR is in a range between 15° and 60°from vertical.

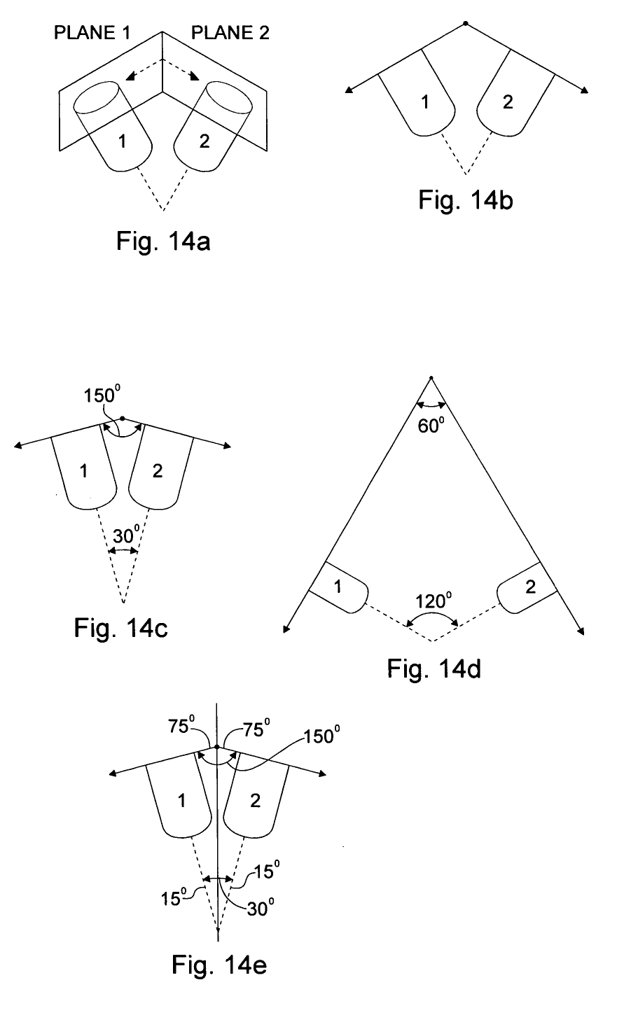

The receptacle angle 86 is intended to be calculated when the device 80, 80a is in a resting position. The resting position of the device 80, 80a is when the device 80, 80a may be oriented as though (i), as illustrated by way of example in FIGS. 37, 38, 40b if the separate receptacles 82 have a common base 92 or bottom 94, the base 92 or bottom 94 of the device 80, 80a is resting stationary and unaided on a horizontal resting place or a level surface, (ii), as illustrated by way of example in FIG. 40a, if the receptacles 82 have separate bases 92 or bottoms 94, the base 92 or bottom 94 of each receptacle 82 is simultaneously resting stationary and unaided on a horizontal resting place or a level surface or (iii), referring now to FIGS. 14a through 14e, if the device 80 and the receptacles 82 do not have bases 92 and/or bottoms 94, the receptacles 82 are in a general vertical orientation such that (a) the axis representing the intersection of two planes placed on the rim portions of each receptacle 82 is horizontal, (b) the angle formed by projecting a line perpendicularly from any particular meeting point along such axis along each such plane in the direction of each such receptacle 82 is equal to or less than 150 degrees and equal to or greater than 60 degrees and (c) a vertical plane projected downward from such axis bisects such angle such that the angle formed by the vertical plane and the plane of one such other receptacle 82 is equal to the angle formed by the vertical plane and the plane of the other such other receptacle 82.

Referring now to FIGS. 37 and 38, by way of example and not intending to be limiting, the base 92 of the device 80, 80a or of a receptacle 82 can be a flattened portion appended to the device 80, 80a or receptacle 82 so that it may rest stationary and unaided on a horizontal resting place or a level surface. Referring now to FIGS. 40a and 40b, by way of example and not intending to be limiting, the bottom 94 of the device 80, 80a or of a receptacle 82 can be a flattened portion of the device 80, 80a or receptacle 82 (generally opposite the lip portions 100 of each receptacle 82 of the device 80, 80a) on which the device 80, 80a or receptacle 82 may rest in a stationary and unaided manner on a horizontal resting place or a level surface.

As seen in Figs. including 8-13, in the resting position, because the receptacles 82 are angled, one side of the receptacle 82 will be toward the horizontal plane, (referred to as the “lead side” 96) and the other side of the receptacle 82 will be toward the vertical plane (referred to as the “back side” 98). The top of the receptacle 82 has a lip portion 100. The lip portion 100 is at the open end 102 of the receptacle 82. Generally the lip portion 100 is the open end 102 on at least a portion of which the user's lips would be placed to drink from the receptacle 82. When the lip portion 100 is round in shape, the location of the lip portion 100 that is angled most closely to the horizontal plane is called the lead point, which in these illustrations is generally designated by the letter “A” for explanatory purposes only; and the location of the lip portion 100 that is angled most closely to the vertical plane is called the back point, which in these illustrations is generally designated by the letter “Y” for explanatory purposes only.

Reference is now made to FIGS. 18-21, wherein it is illustrated that the lead side 96 may have a variety of shapes, including straight, concave and slightly convex. In addition, a lead side and a back side that are angled with relatively straight but angled lines are also intended to be included. If a receptacle has a slight convex angle, when the equation is used, there could be a slight amount of liquid 112 remaining in the receptacle when it is at the drinking angle. This could be compensated for by leaving liquid 112 in the receptacle after drinking, by indicating a maximum fill-line 84 which is lower than the maximum fill-line 84 otherwise appropriate under the equation, or by using a receptacle with a reservoir 104, which is subsequently described in more detail. As illustrated in FIGS. 52 and 54, the drinking receptacle 82 will be at its minimum full drinking angle when the line (A-B) is parallel to a level surface. This is the angle at which a drinker could pour out all, or substantially all, of the liquid 112 in the receptacle.

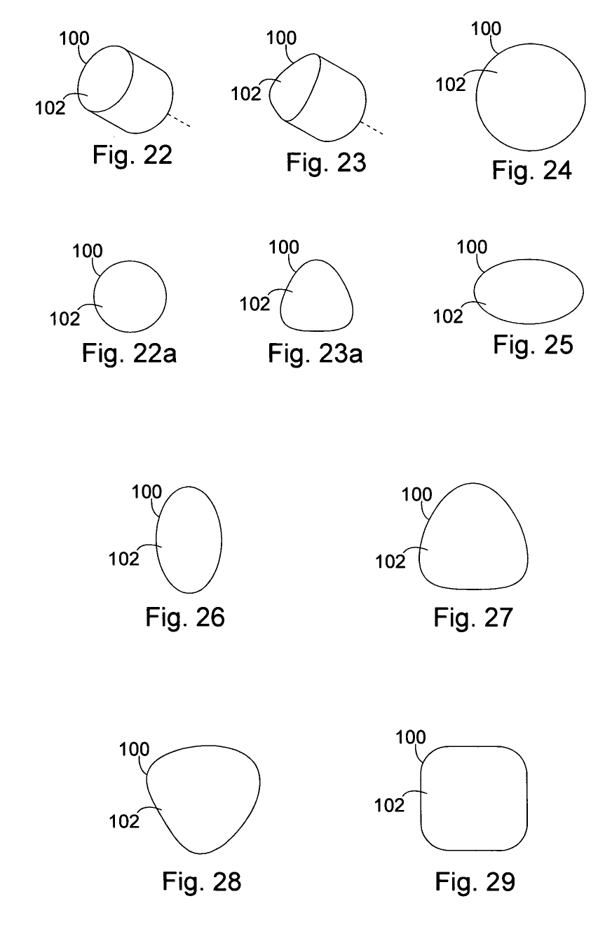

As seen in FIGS. 22-29, it is intended that the device 80, 80a of the current invention will be applicable for receptacles 82 and lip portions 100 that come in a variety of shapes and sizes. FIGS. 22 through 29 illustrate a variety of shapes that the receptacle 82 open portion 102 may have. However, it is to be understood that these shapes that are illustrated are intended to be exemplary and not limiting.

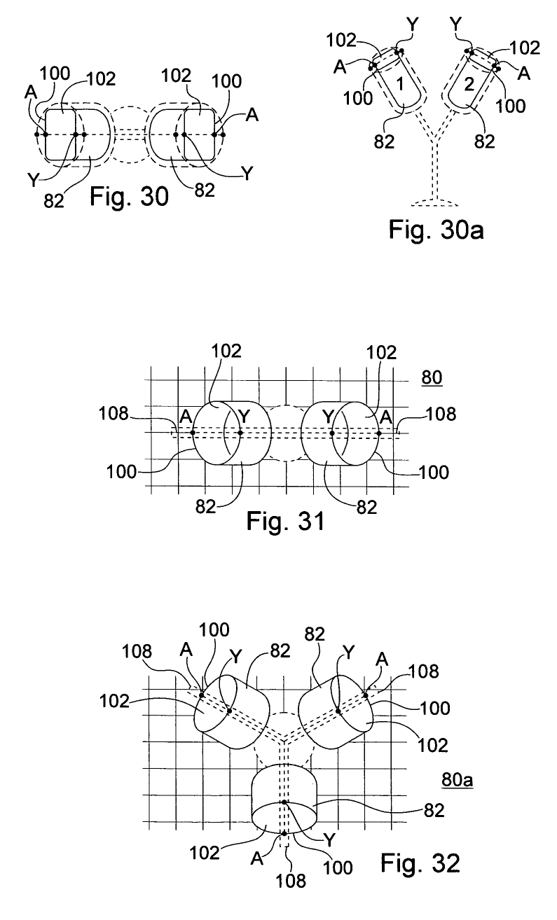

As illustrated in FIGS. 30 and 30a, when the lip portion 100 is not round in shape (referred to as “globular-shaped” for explanatory purposes only), the lead point and back point may be determined by the following on the receptacle 82 not having a round lip portion 100: a) actually placing a, or projecting the location of an imaginary, basically cylindrical receptacle 82 having a round lip portion 100 over the basic outline of the interior of the globular-shaped receptacle 82; b) determining where the lead point and back point would be on the round lip portion 100; and c) locating the lead point and back point of the globular-shaped lip portion 100 where a line projected between the lead point and back point of the round lip portion 100 intersects the globular-shaped lip portion 100.

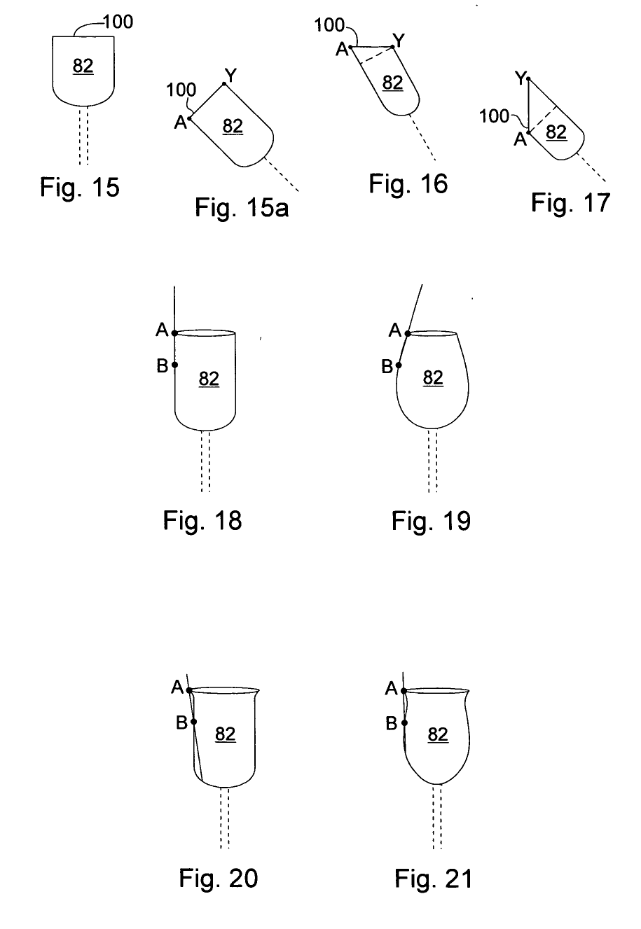

Further, as seen in FIGS. 15-17, the lead point A and/or the back point Y could be extended. In addition, the lip portion 100 can be flat, nearly flat or extended. When in the resting position, it is preferred that the lead point A is not higher than the back point Y.

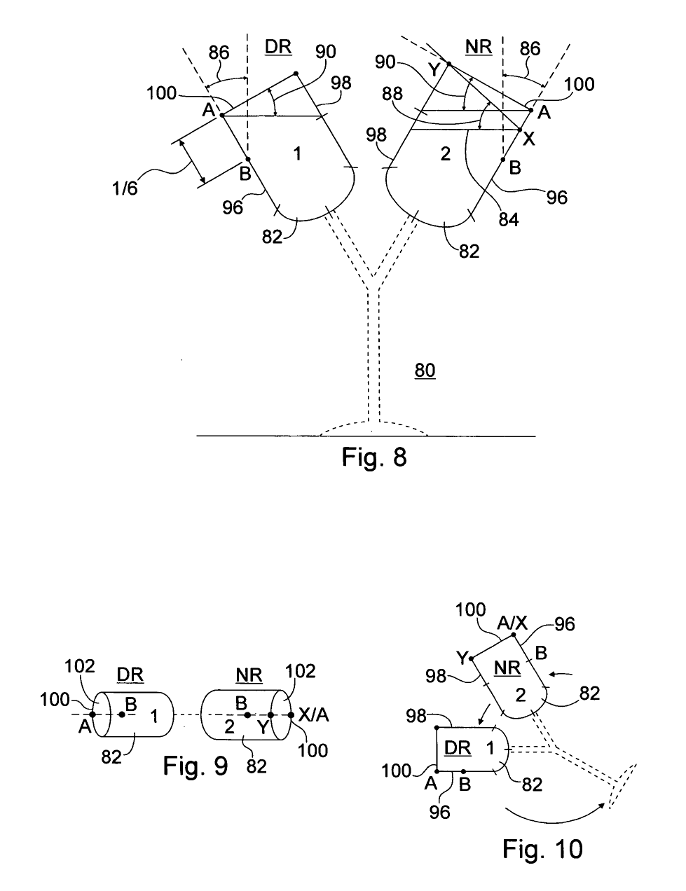

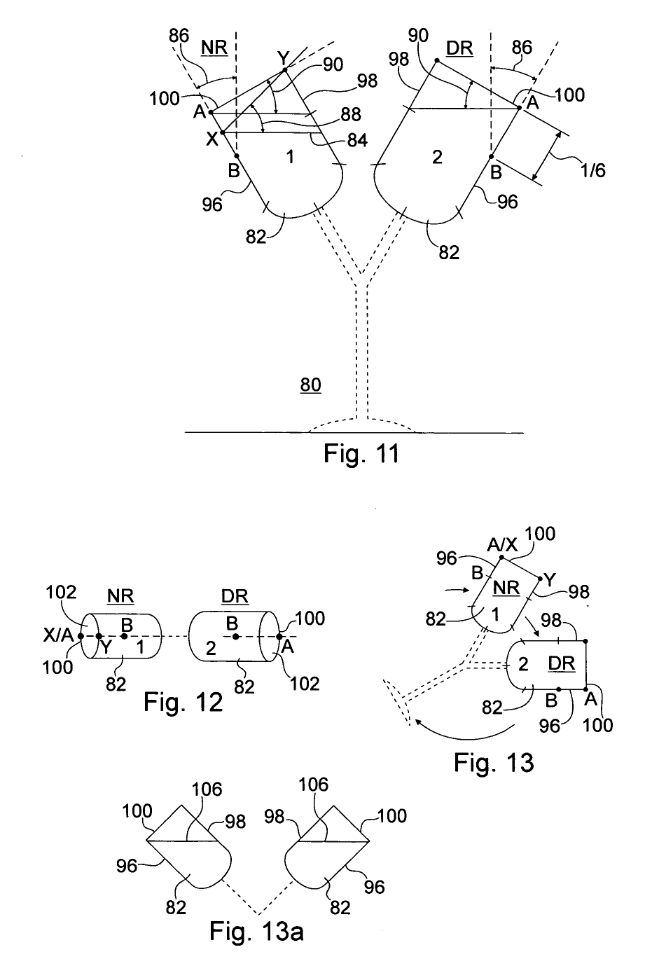

Referring now to FIGS. 8 and 11, to calculate the lip angle 90, an imaginary or real line is projected from the lead point to the back point. Then an imaginary or real line is projected from the lead point horizontally to the back edge. The angle between these two lines is the lip angle 90. This calculation is done when the receptacle 82 is in a resting position.

As further illustrated in FIGS. 8 and 11, to calculate the receptacle angle 86, the interior surface of the receptacle 82 is divided into six equal portions. The location of the first one-sixth portion measured along the lead edge directly from the lead point is called the “one-sixth point”, and which is designated by a “B” in the illustrations for explanatory purposes only. To calculate the receptacle angle 86, an imaginary or real line is projected between the lead point and the one-sixth point, and an imaginary or real line is projected upward vertically from the one-sixth point. The receptacle angle 86 is the angle created where these two lines intersect. This calculation is done when the receptacle 82 is in a resting position.

As further illustrated in FIGS. 8 and 11, the spill angle 88 is also calculated from the resting position. The spill angle 88 is calculated on the NR. Specifically, the NR has a lead side 96, which is the side that is closest to the horizontal plane. In addition, the NR 82 will have a horizontal fill-line 84, which is the line up to which the receptacle 82 may be filled with liquid 112, to which a receptacle is filled with liquid 112, or is indicated as the point up to which the receptacle 82 could be filled with liquid 112 and still fall within the parameters of the formulae of the invention. It is to be understood that the maximum fill-line 84 could be a designation on a receptacle 82 that is known, calculated or determined, and/or it could be a designation that is physically indicated on the receptacle 82 by means of some indicia 106, that is based on the formulae of the current invention. Among others, an example of a maximum fill-line that is indicated with indicia is illustrated in FIG. 13a.

The point along the lead side 96 where the horizontal fill-line 84 intersects the lead side 96 is called the intersection point, which is indicated by the letter “X” in the illustrations for explanatory purposes only. The NR further has a back side 98, which is the side of the receptacle 82 that is closest to the vertical axis. Further, the back point of the lip portion 100 is indicated by the letter “Y” for explanatory purposes only. The back point of the lip portion 100 is the point of the lip portion 100 which is closest to the vertical axis. Using these coordinates, the spill angle 88 is calculated as follows: the angle between an imaginary or real line projecting horizontally across the fill-line 84 and an imaginary or real line projecting from the intersection point through the back point.

The maximum fill-line 84 of the NR marks where a receptacle 82 is filled or fillable to a capacity where the resulting spill angle 88 is the minimum possible angle that (i) satisfies either (a) 90° minus the receptacle angle of the DR is less than or equal to the spill angle of the NR plus the receptacle angle of the NR, or (b) 90° minus the receptacle angle of the DR is less than or equal to two times the spill angle of the NR, and (ii) is equal to or greater than the lip angle of the NR.

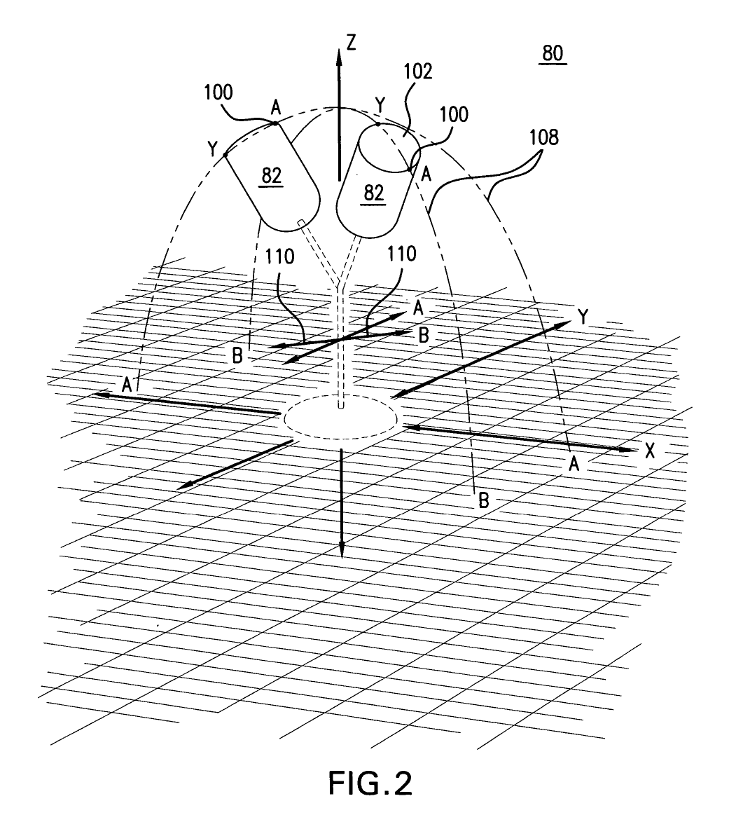

As most clearly seen in FIGS. 1, 2, 34-36, each receptacle 82 has a tilt plane 108 and a tilt axis 110. The tilt plane 108 is the plane along which the lead point is intended to travel while the user tilts the device 80 from the resting position to drink from the DR. As seen in these Figures, the lead point A and the back point Y travel along generally the same tilt plane 108 toward the mouth of the user. As previously indicated, it is intended that the user will drink from the DR at the lead position A. The tilt axis 110 is the axis at which the device 80 pivots when the user tilts the device 80 toward the user's lips. As seen most clearly in FIGS. 1-2, the tilt axis 110 is generally parallel to horizontal and perpendicular to the tilt plane 108.

As seen most clearly in FIGS. 1 and 31, when the DR and the NR are aligned on the same tilt plane 108, when the user tilts the device 80 to take a drink, the back point Y of the DR will follow the lead point A of the DR along the plane, and then the back point Y of the NR followed by the lead point A of the NR will follow the back point Y of the DR along the same plane.

In addition, as seen most clearly in FIGS. 2 and 34-36, the DR and the NR can be on tilt planes 108 that are slightly divergent.

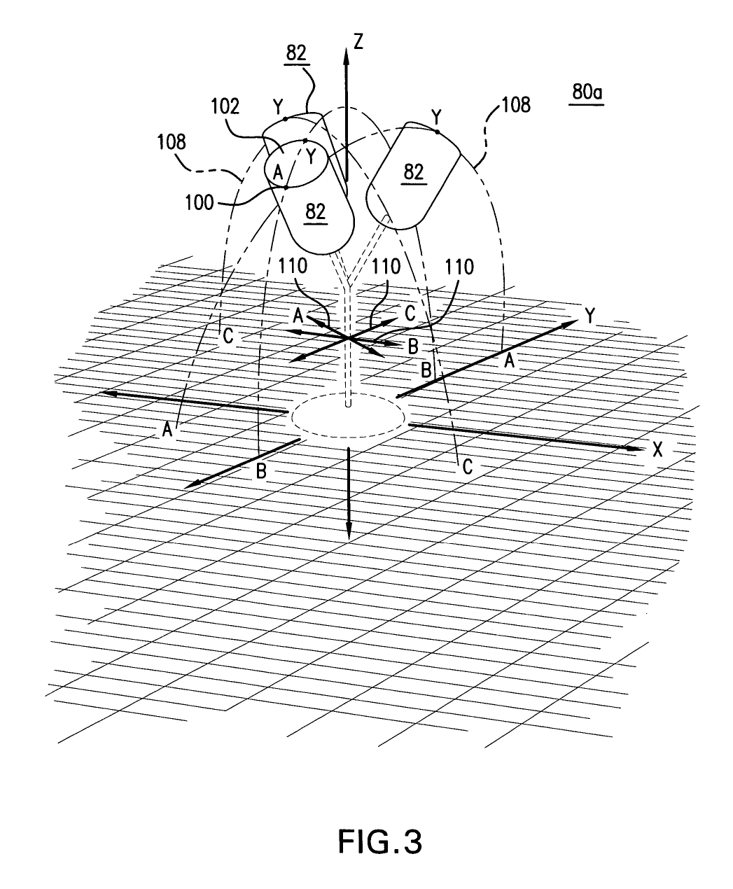

Reference is now made to FIGS. 3, and 32-33a, which illustrate a device 80a, which contains three receptacles 82, for holding liquids 112 for drinking by a user. The receptacles 82 are non-contiguous with each other such that liquid 12 from one receptacle 82 cannot readily flow from one receptacle 82 to the others. Each receptacle 82 has a receptacle angle 86 that is generally 45° from vertical. It is to be noted, that the receptacle angle 86 for this device 80a is calculated as previously described for the two-receptacle 82 embodiments. Specifically, each receptacle 82 has a lip portion 100, and a lead point A on the lip portion 100 as previously described, along with a one-sixth point on the lead end of the receptacle 82. The angle of the receptacles 82 in mutual relationship to one another is determined as follows: when the device 80a is in a resting position, the lead point, as projected toward horizontal plane, will be generally 120°from each other lead point projected toward the horizontal plane. Each vessel will be fillable with liquid 112 to a certain fill-line 84 such that when from any one vessel liquid 112 is drunk while being tilted on the tilt plane 108, the liquid 112 in the two non-drinking receptacles 82 will not spill out of the receptacle 82. The tilt plane 108 is the plane along which the lead point is intended to travel while the user tilts the device 80 from the resting position to drink from the DR. As seen in these Figures, the lead point A and the back point Y travel along generally the same tilt plane 108 toward the mouth of the user. As previously indicated, it is intended that the user will drink from the DR at the lead point A. The tilt axis 110 is the axis at which the device 80a pivots when the user tilts the device 80a toward the user's lips.

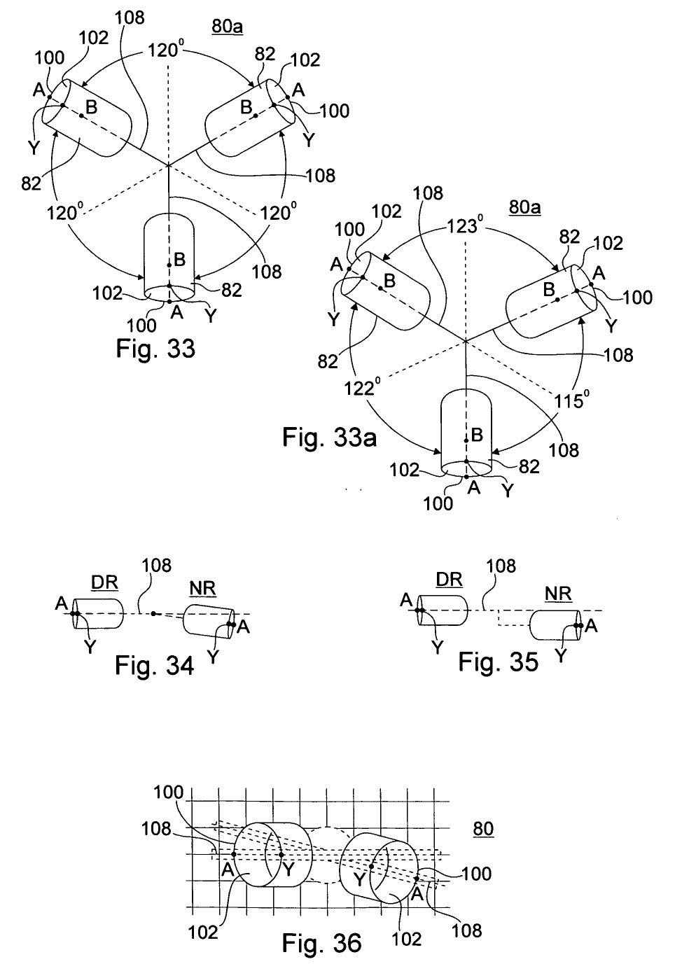

Referring now to FIGS. 3 and 32, in a device 80a that has three receptacles 82 that are generally equally spaced from one another, which is preferred, the receptacles will each have a tilt plane 108 which is generally 120° from the other tilt planes 108 of the other receptacles 82. However, as seen in FIG. 33a, the tilt planes can be slightly non-aligned from 120° from each other, and the spirit of the invention will still be satisfied.

The receptacles 82 may be affixed on a device 80, 80a in any manner currently known or to be discovered in the art, as long as the relative angles of the receptacles 82 fall within the parameters of the invention. While not intending to be limiting, FIGS. 37-43 illustrate ways that the receptacles 82 can be affixed to the device 80, 80a of the current invention. The receptacles 82 have outside portions 116. As seen in FIGS. 37, 38, 39 and 41 the device 80, 80a can include at least one stem 114. The receptacles 82 can be each affixed to the stem 114, or can be affixed to one another, and then affixed to the stem 114. In other embodiments, the device 80, 80a may not include a stem 114. In addition, it is to be noted that in some embodiments, a base 92, may be included or may be optional. In addition, the base 92 could be positioned, sized and/or weighted to counteract the weight of the receptacles 82. By way of example, and not intending to be limiting, a base 92 could be elongated or have additional weight to counteract the weight of the receptacles 82.

In FIG. 38, the device 80, 80a includes a common stem 114 and two separate stems 114. In these embodiments, each receptacle 82 has its own separate stem 114 attaching the receptacle 82 to the remainder of the device 80, 80a. Each separate stem 114 is attached on one end to the receptacle 82 and on the other end to the common stem 114.

Further, in FIG. 41, each receptacle 82 is attached to a separate stem 114. In this embodiment, each stem 114 is attached to a separate receptacle 82 on one end and attached to a base 92 on the other end. It is to be noted, that when the receptacle is attached to a separate stem 114, the separate stem 114 generally will have an angle off vertical, which is referred to as the stem 114 angle.

As illustrated in FIGS. 38 and 41, the stem 114 angle can be the same angle as the receptacle angle 86 for the receptacle 82 to which the stem 114 is attached, or, as illustrated in FIG. 37, at least one stem 114 angle it can be a different angle that the receptacle angle 86.

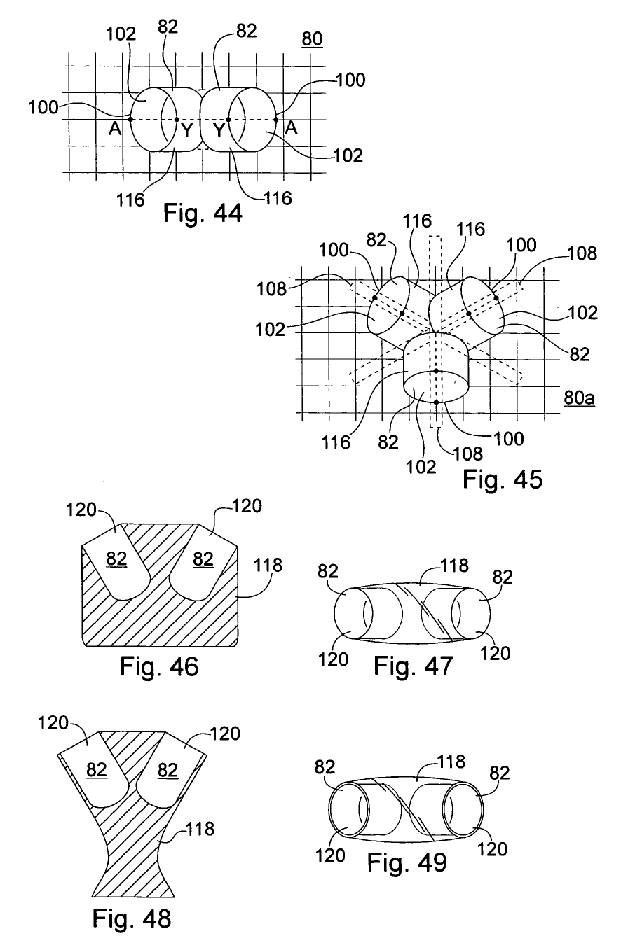

As illustrated in FIGS. 39-40b, 44 and 45, the receptacles 82 can be attached to one another at the outside portion 116 of each receptacle 82. The receptacles 82 optionally can further attach to a stem 114 as illustrated in FIG. 39, or to a base 92, as illustrated in FIG. 40. FIG. 44 is a top view of two receptacles 82 connected to each other at the outside portion 116, and FIG. 45 is a top view of three receptacles 82 connected to each other at the outside portion 116.

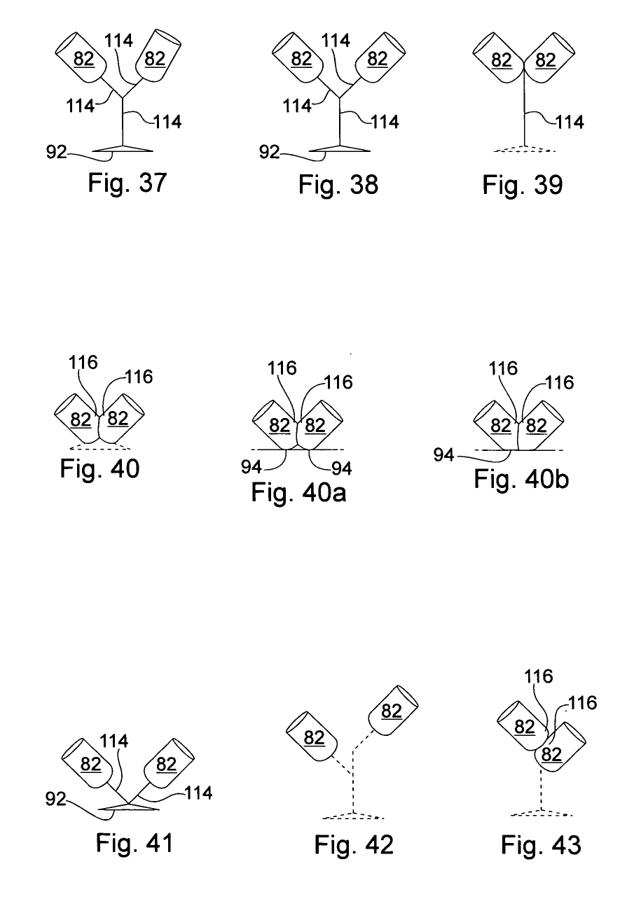

Reference is now made to FIGS. 42 and 43. As illustrated in these figures, the distance of the lead point A on one receptacle 82 can be the same or different than the distances of the lead point A on the other receptacle or receptacles 82 from a horizontal resting plane.

Reference is now made to FIGS. 46 through 49. In these Figures, the receptacles 82 are embedded in a block of at least one material. The receptacles 82 are indentations 120 in the generally solid block 118 or the generally solid portion of the block 118, having the requisite angles of the invention. The block could be made of any materials currently known in the art or to be discovered which could hold a shape, such as, but not limited to, stone, glass or ceramic.

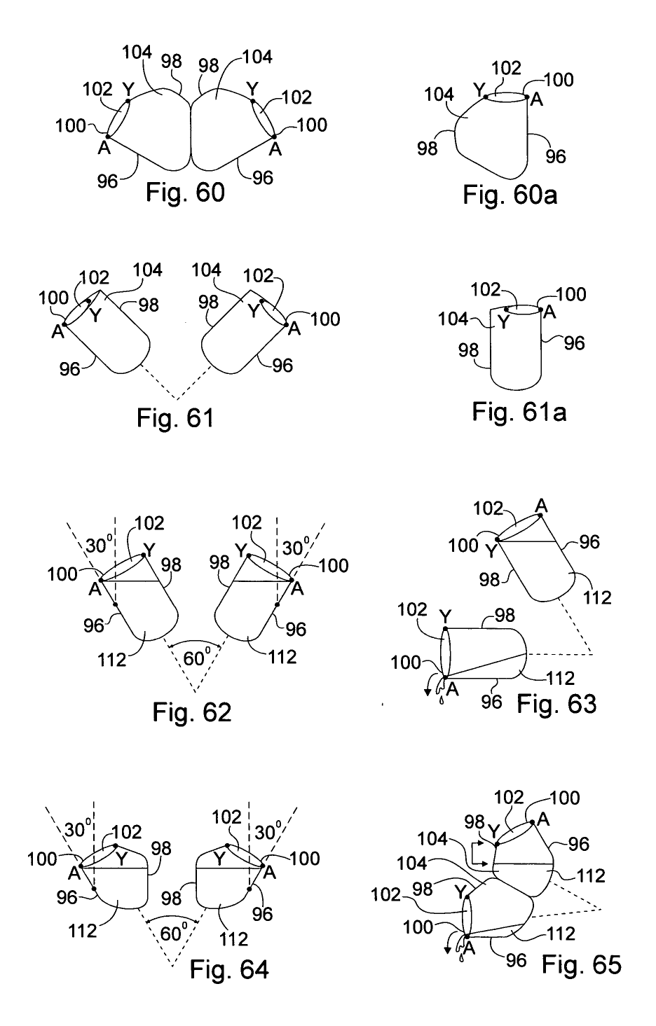

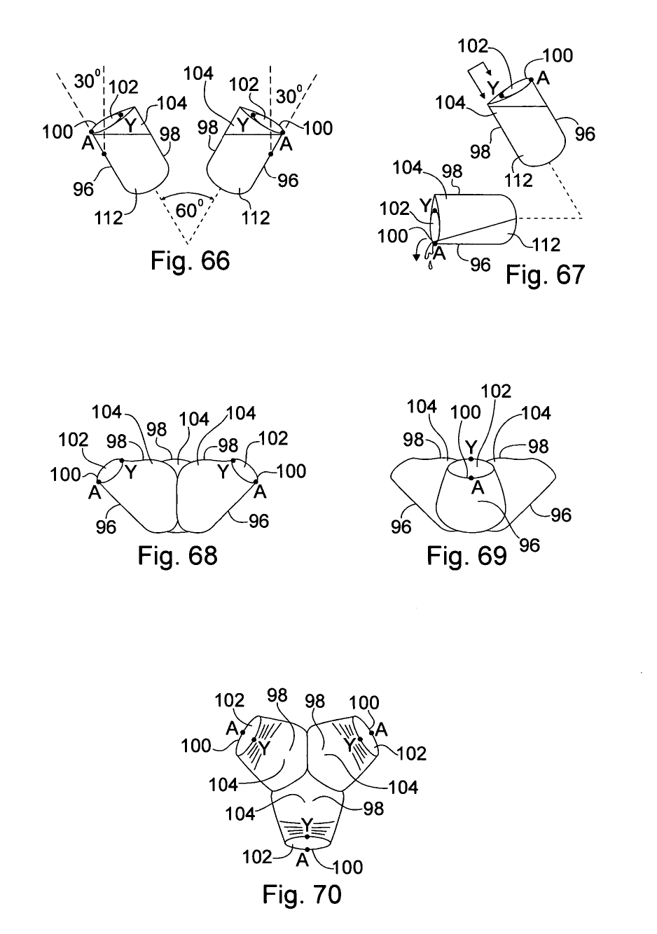

Reference is now made to FIGS. 60 through 70. FIGS. 60-61a are side views of embodiments of the invention having reservoirs 104. FIGS. 62-63 are side views of embodiments of the invention not having reservoirs that show a comparison with FIGS. 64-67 which are side views of embodiments of the invention having reservoirs 104. FIGS. 64-67 are side views of embodiments of the invention having reservoirs 104 that show a comparison with FIGS. 62-63 which are side views of embodiments of the invention not having reservoirs. FIGS. 68-69 are side views of embodiments of the invention having reservoirs 104. FIG. 70 is a top view of an embodiment of the invention having reservoirs 104.

These illustrations illustrate a device 80, 80a for holding liquids 112 for drinking by a user wherein the device 80, 80a has a side portion which has a reservoir 104 area. The reservoir 104 area will cause liquid 112 in the receptacle 82 to gather in the reservoir 104 when the vessel is tilted toward the reservoir 104. By way of example, and not intending to be limiting, as illustrated in FIGS. 60, 60a, 64, 65, and 68-70, the reservoir 104 area can be made by adding a concave portion to the side of the vessel which has the reservoir. Alternatively, by way of example, and not intending to be limiting, as illustrated in FIGS. 61, 61a, 66 and 67, the reservoir 104 can be created by closing a portion of the upper lip portion 100 of the receptacle.

As seen in these Figures, when the reservoir 104 area is placed on a device 80, 80a having at least two receptacles 82, the reservoir 104 area is positioned on the back side 98 of the receptacle 82, being the side that is toward the vertical axis when the device 80, 80a is in the resting position.

In addition, when the receptacle having a reservoir 104 area is attached to the device 80, 80a of the current invention, when the user tilts the device 80, 80a to drink from the drinking receptacle 82, the non-drinking receptacle 82 has the added reservoir 104 area for the liquid 112 in the non-drinking receptacle or receptacles 82 to flow before the liquid 112 spills. As a result, the previously described calculations (90° minus the receptacle angle of the DR is less than or equal to the spill angle plus the receptacle angle of the NR, and 90° minus the receptacle angle of the DR is less than 2 times the spill angle of the NR) can be relaxed somewhat.

By way of example, and not intending to be limiting, FIGS. 62-67 illustrate the benefits of receptacles 82 having reservoirs 104 compared with receptacles 82 not having reservoirs. Specifically, as illustrated in FIGS. 62 and 63, when receptacles 82 not having a reservoirs are in use, the liquid 112 in the NR is much closer to spilling than the liquid 112 in the NR, as illustrated in FIGS. 64-67, when receptacles 82 having reservoirs 104 are in use.

FIGS. 60a and 61a illustrate individual receptacles 82 that include reservoirs 104.

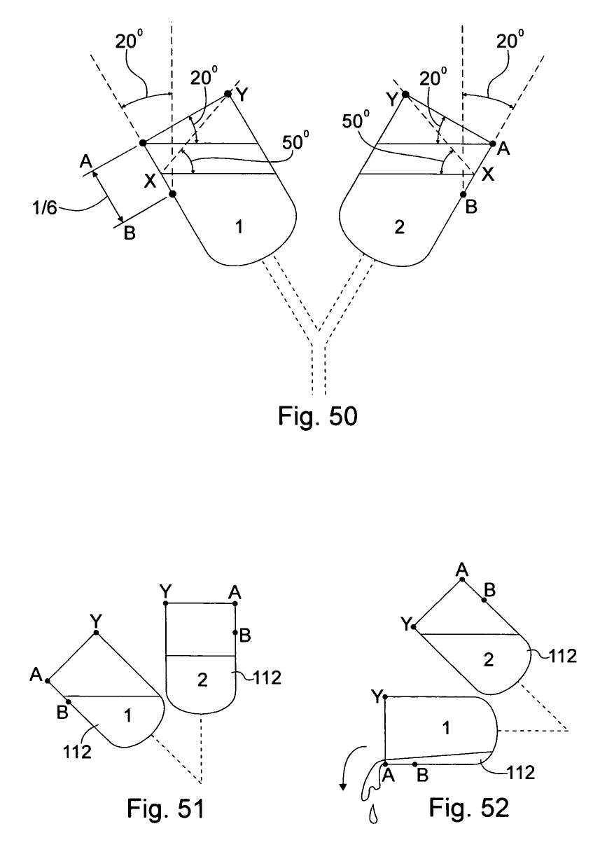

FIGS. 50, 53, and 55-59 illustrate various embodiments of the invention. While describing these Figures, the RA, SA and LA of receptacle 1 will be indicated by RA1, SA1 and LA1, respectively; the RA, SA and LA of receptacle 2 will be indicated by RA2, SA2 and LA2, respectively. The symbol “<=” means “less than or equal to”.

In FIG. 50, each of receptacle 1 and receptacle 2 has a Receptacle Angle of 20°, Spill Angle of 50° and Lip Angle of 20° If receptacle 1 is the DR and receptacle 2 is the NR, because LA2 (20°) is greater than or equal to RA2 (20°), 90°−RA1<=SA2+RA2 will be applied to determine whether the device will function as described within this invention when drinking from receptacle 1. Thus, inserting the applicable numbers, the calculation is 90−20<=50+20, which becomes 70<=70. Thus, when receptacle 1 is the DR and receptacle 2 is the NR, the device, when filled to or below the capacities indicated, will function as described within this invention. If receptacle 2 is the DR and receptacle 1 is the NR, because LA1 (20°) is greater than or equal to RA1 (20°), 90°−RA2<=SA1+RA1 will be applied. Thus, inserting the applicable numbers, the calculation is 90−20<=50+20, which becomes 70<=70. Thus, when receptacle 2 is the DR and receptacle 1 is the NR, the device, when filled to or below the capacities indicated, will function as described within this invention.

FIGS. 51 and 52 illustrate FIG. 50 in use when the receptacle identified as receptacle “1” for explanatory purposes only is the DR.

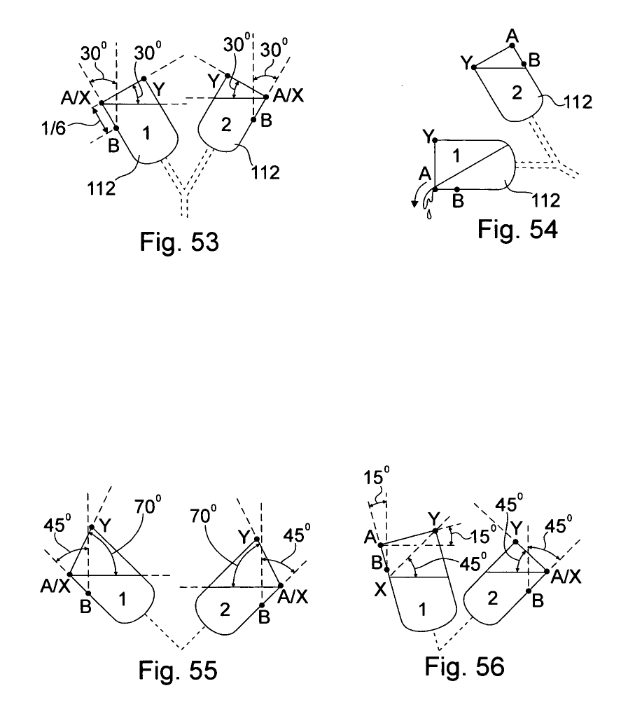

In FIG. 53, RA1=30°, SA1=30°, LA1=30°, RA2=30°, SA2=30° and LA2=30°. If receptacle 1 is the DR and receptacle 2 is the NR, because LA2 (30°) is greater than or equal to RA2 (30°), 90°−RA1<=SA2+RA2 will be applied. Thus, inserting the applicable numbers, the calculation is 90−30<=30+30, which becomes 60<=60. Thus, when receptacle 1 is the DR and receptacle 2 is the NR, the device, when filled to or below the capacities indicated, will function as described within this invention. If receptacle 2 is the DR and receptacle 1 is the NR, because LA1 (30°) is greater than or equal to RA1 (30°), 90°−RA2<=SA1+RA1 will be applied. Thus, inserting the applicable numbers, the calculation is 90−30<=30+30, which becomes 60<=60. Thus, when receptacle 2 is the DR and receptacle 1 is the NR, the device, when filled to or below the capacities indicated, will function as described within this invention.

In FIG. 55, RA1=45°, SA1=70°, LA1=70°, RA2=45°, SA2=70° and LA2=70°. If receptacle 1 is the DR and receptacle 2 is the NR, because LA2 (70°) is greater than or equal to RA2 (45°), 90°−RA1<=SA2+RA2 is applied. Thus, inserting the applicable numbers, the calculation is 90−45<=70+45, which becomes 45<=115. Thus, when receptacle 1 is the DR and receptacle 2 is the NR, the device, when filled to or below the capacities indicated, will function as described within this invention. If receptacle 2 is the DR and receptacle 1 is the NR, because LA1 (70°) is greater than or equal to RA1 (45°), 90°−RA2<=SA1+RA1 is applied. Thus, inserting the applicable numbers, the calculation is 90−45<=70+45, which becomes 45<=115. Thus, when receptacle 2 is the DR and receptacle 1 is the NR, the device, when filled to or below the capacities indicated, will function as described within this invention.

In FIG. 56, RA1=15°, SA1=45°, LA1=15°, RA2=45°, SA2=45° and LA2=45°. If receptacle 1 is the DR and receptacle 2 is the NR, because LA2 (45°) is greater than or equal to RA2 (45°), 90°−RA1<=SA2+RA2 is applied. Thus, inserting the applicable numbers, the calculation is 90−15<=45+45, which becomes 75<=90. Thus, when receptacle 1 is the DR and receptacle 2 is the NR, the device, when filled to or below the capacities indicated, will function as described within this invention. If receptacle 2 is the DR and receptacle 1 is the NR, because LA1 (15°) is greater than or equal to RA1 (15°), 90°−RA2<=SA1+RA1 is applied. Thus, inserting the applicable numbers, the calculation is 90−45<=45+15, which becomes 45<=60. Thus, when receptacle 2 is the DR and receptacle 1 is the NR, the device, when filled to or below the capacities indicated, will function as described within this invention.

In FIG. 57, RA1=45°, SA1=45°, LA1=45°, RA2=45°, SA2=45° and LA2=45°. If receptacle 1 is the DR and receptacle 2 is the NR, because LA2 (45°) is greater than or equal to RA2 (45°), 90°−RA1<=SA2+RA2 is applied. Thus, inserting the applicable numbers, the calculation is 90−45<=45+45, which becomes 45<=90. Thus, when receptacle 1 is the DR and receptacle 2 is the NR, the device, when filled to or below the capacities indicated, will function as described within this invention. If receptacle 2 is the DR and receptacle 1 is the NR, because LA1 (45°) is greater than or equal to RA1 (45°), 90°−RA2<=SA1+RA1 is applied. Thus, inserting the applicable numbers, the calculation is 90−45<=45+45, which becomes 45<=90. Thus, when receptacle 2 is the DR and receptacle 1 is the NR, the device, when filled to or below the capacities indicated, will function as described within this invention.

In FIG. 58, RA1=45°, SA1=22.5°, LA1=0°, RA2=45°, SA2=22.5° and LA2=0°. If receptacle 1 is the DR and receptacle 2 is the NR, because LA2 (0°) is less than RA2 (45°), 90°−RA1<=2×SA2 is applied. Thus, inserting the applicable numbers, the calculation is 90−45<=2×22.5, which becomes 45<=45. Thus, when receptacle 1 is the DR and receptacle 2 is the NR, the device, when filled to or below the capacities indicated, will function as described within this invention. If receptacle 2 is the DR and receptacle 1 is the NR, because LA1 (0°) is less than RA1 (45°), 90°−RA2,=2×SA1 is applied. Thus, inserting the applicable numbers, the calculation is 90−45<=2×22.5, which becomes 45<=45. Thus, when receptacle 2 is the DR and receptacle 1 is the NR, the device, when filled to or below the capacities indicated, will function as described within this invention.

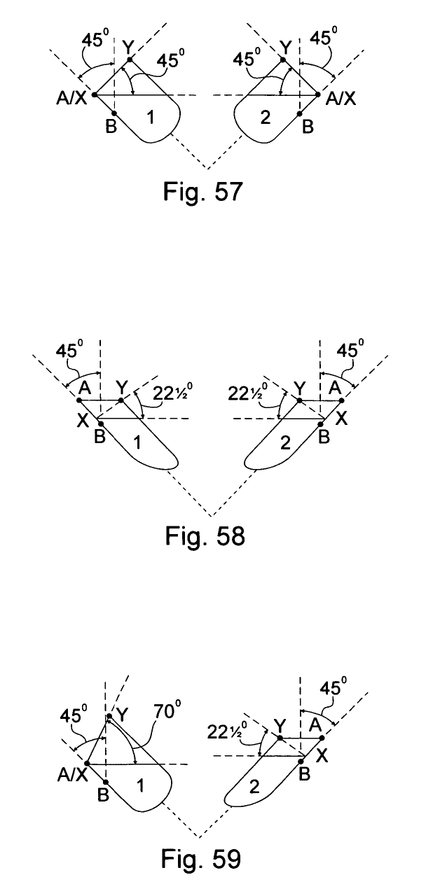

In FIG. 59, RA1=45°, SA1=70°, LA1=70°, RA2=45°, SA2=22.5° and LA2=0°. If receptacle 1 is the DR and receptacle 2 is the NR, because LA2 (0°) is less than RA2 (45°), 90°−RA1<=2×SA2 is applied. Thus, inserting the applicable numbers, the calculation is 90−45<=2×22.5, which becomes 45<=45. Thus, when receptacle 1 is the DR and receptacle 2 is the NR, the device, when filled to or below the capacities indicated, will function as described within this invention. If receptacle 2 is the DR and receptacle 1 is the NR, because LA1 (70°) is greater than or equal to RA1 (45°), 90°−RA2<=SA1+RA1 is applied. Thus, inserting the applicable numbers, the calculation is 90−45<=45+70, which becomes 45<=115. Thus, when receptacle 2 is the DR and receptacle 1 is the NR, the device, when filled to or below the capacities indicated, will function as described within this invention.

Although the invention has been illustrated by reference to specific embodiments, it will be apparent to those of ordinary skill in the art that various changes and modifications may be made which clearly fall within the scope of the invention. The invention is intended to be protected broadly within the spirit and scope of the appended claims.

What is claimed is:

1. A device for holding liquids for drinking by a user, said device comprising:
two receptacles;
each said receptacle further comprising a receptacle angle, a resting position, a lead point and a one-sixth point, whereby said receptacle angle is comprised of the angle formed between a line projected between said one-sixth point and said lead point and a line projected upward vertically from said one-sixth point when said device is in said resting position;
each said receptacle further comprising a spill angle, a fill-line and a lead side, said lead side and said fill-line intersecting at an intersection point, each said receptacle further comprising a back side and a lip portion, said lip portion further comprising a back point, whereby said spill angle comprises the angle formed between a line projected horizontally across said fill-line from said intersection point toward said back side and a line projected from said intersection point toward said back point when said receptacle is in said resting position;
each said receptacle further comprising a lip angle, said lip angle being comprised of the angle from horizontal of a line projected from said lead point to said back point when said receptacle is in a resting position, each said lip angle of each said two receptacles being greater than or equal to its respective receptacle angle;
whereby each said receptacle is fixated in mutual relationship with the other said receptacle whereby, in one of said two receptacles, 90 degrees minus the receptacle angle is equal to or less than, in the other one of said two receptacles, the spill angle plus the receptacle angle.

2. The device of claim 1, wherein said fill-line on at least one of said two receptacles is a maximum fill-line.

3. The device of claim 2, wherein said fill-line on each of said two receptacles is a maximum fill-line.

4. The device of claim 2, said device further comprising a first receptacle and a second receptacle wherein said maximum fill-line is comprised of the level to which first receptacle can be filled to a capacity where said spill angle is the minimum angle that satisfies both (1) in said second receptacle, 90 degrees minus the receptacle angle is equal to or less than, in said first receptacle, the spill angle plus the receptacle angle, and (2) is equal to or greater than the lip angle of said first receptacle.

5. The device of claim 1, wherein said device further comprises a liquid, said fill-line further comprising a horizontal liquid surface level.

6. The device of claim 1, wherein said fill-line further comprises indicia.

7. The device of claim 1, wherein said fill-line further comprises instructions.

8. The device of claim 1, wherein said lead side is generally straight.

9. The device of claim 1, wherein said lead side is generally concave.

10. The device of claim 1, wherein said device further comprises at least one stem, at least one said receptacle being attached to said device by said at least one stem.

11. The device of claim 10, wherein said at least one stem comprises a common stem.

12. The device of claim 10, wherein said at least one stem comprises two separate stems, one of said two receptacles being separately attached to said device by one of said two separate stems, and the other of said two receptacles being separately attached to said device by the other of said two separate stems.

13. The device of claim 10, wherein said at least one stem comprises further comprises two separate stems.

14. The device of claim 10, wherein said at least one stem has at least one stem angle, said stem angle being different than the receptacle angle of said at least one receptacle.

15. The device of claim 10, wherein said at least one stem has at least one stem angle, said stem angle being the same as the receptacle angle of said at least one receptacle.

16. The device of claim 1, wherein each of said two receptacles has an outside portion, each one of said two receptacles being attached to said other of said two receptacles at said outside portion.

17. The device of claim 1, wherein each of said receptacles is rotatable on a tilt plane, said tilt plane generally aligning with said lead point.

18. The device of claim 17, whereby said tilt plane for each of said receptacles is generally the same.

19. The device of claim 1, wherein said resting position further comprises a horizontal resting plane, the distance of said horizontal resting plane from said lead point on one of said two receptacles is different than the distance of said horizontal resting plane from said lead point on the other one of said two receptacles.

20. The device of claim 1, wherein said resting position further comprises a horizontal resting plane, the distance of said horizontal resting plane from said lead point on one of said two receptacles is generally the same as the distance of said horizontal resting plane from said lead point on the other one of said two receptacles.

21. The device of claim 1, wherein said device further comprises generally a block of at least one material, each of said two receptacles further embedded within said block.

22. The device of claim 1, at least one of said two receptacles having a back side, said back side having a reservoir.

23. A device for holding liquids for drinking by a user, said device comprising:
two receptacles;
each said receptacle further comprising a receptacle angle, a resting position, a lead point and a one-sixth point, whereby said receptacle angle is comprised of the angle formed between a line projected between said one-sixth point and said lead point and a line projected upward vertically from said one-sixth point when said device is in said resting position;
each said receptacle further comprising a spill angle, a fill-line and a lead side, said lead side and said fill-line intersecting at an intersection point, each said receptacle further comprising a back side and a lip portion, said lip portion further comprising a back point, whereby said spill angle comprises the angle formed between a line projected horizontally across said fill-line from said intersection point toward said back side and a line projected from said intersection point toward said back point when said receptacle is in said resting position;
each said receptacle further comprising a lip angle, said lip angle being comprised of the angle from horizontal of a line projected from said lead point to said back point when said receptacle is in a resting position, each said lip angle of each said two receptacles being less than its respective receptacle angle; and
whereby each said receptacle is fixated in mutual relationship with the other said receptacle whereby, in one said receptacle, 90 degrees minus the receptacle angle is equal to or less than, in the other said receptacle, two times the spill angle.

24. The device of claim 23, wherein said fill-line on at least one of said receptacles is a maximum fill-line.

25. The device of claim 24, wherein said fill-line on each of said two receptacles is a maximum fill-line.

26. The device of claim 24 wherein said device further comprises a first receptacle and a second receptacle, said maximum fill-line is comprised of the level to which said first receptacle can be filled to a capacity where the resulting spill angle is the minimum angle that satisfies both (1) in said second receptacle, degrees minus the receptacle angle is equal to or less than, in said first receptacle, two times the spill angle, and (2) is equal to or greater than the lip angle of said first receptacle.

27. The device of claim 23, wherein said device further comprises a liquid, said fill-line further comprising a horizontal liquid surface level.

28. The device of claim 23, wherein said fill-line further comprises indicia.

29. The device of claim 23, wherein said fill-line further comprises instructions.

30. The device of claim 23, wherein said lead side is generally straight.

31. The device of claim 23, wherein said lead side is generally concave.

32. The device of claim 23, wherein said device further comprises at least one stem, at least one said receptacle being attached to said device by said at least one stem.

33. The device of claim 32, wherein said at least one stem comprises a common stem.

34. The device of claim 32, wherein said at least one stem comprises two separate stems, one of said two receptacles being separately attached to said device by one of said two separate stems, and the other of said two receptacles being separately attached to said device by the other of said two separate stems.

35. The device of claim 32, wherein said at least one stem comprises further comprises two separate stems.

36. The device of claim 32, wherein said at least one stem has at least one stem angle, said stem angle being different than the receptacle angle of said at least one receptacle.

37. The device of claim 32, wherein said at least one stem has at least one stem angle, said stem angle being the same as the receptacle angle of said at least one receptacle.

38. The device of claim 23, wherein each of said two receptacles has an outside portion, each one of said two receptacles being attached to said other of said two receptacles at said outside portion.

39. The device of claim 23, wherein each of said receptacles is rotatable on a tilt plane, said tilt plane generally aligning with said lead point.

40. The device of claim 39, whereby said tilt plane for each of said receptacles is generally the same.

41. The device of claim 23, wherein said resting position further comprises a horizontal resting plane, the distance of said horizontal resting plane from said lead point on one of said two receptacles is different than the distance of said horizontal resting plane from said lead point on the other one of said two receptacles.

42. The device of claim 23, wherein said resting position further comprises a horizontal resting plane, the distance of said horizontal resting plane from said lead point on one of said two receptacles is generally the same as the distance of said horizontal resting plane from said lead point on the other one of said two receptacles.

43. The device of claim 23, wherein said device further comprises generally a block of at least one material, each of said two receptacles further embedded within said block.

44. The device of claim 23, at least one of said two receptacles having a back side, said back side having a reservoir.

45. A device for holding liquids for drinking by a user, said device comprising:
two receptacles, said receptacles being a first receptacle and a second receptacle;
each said receptacle further comprising a receptacle angle, a resting position, a lead point and a one-sixth point, whereby said receptacle angle is comprised of the angle formed between a line projected between said one-sixth point and said lead point and a line projected upward vertically from said one-sixth point when said device is in said resting position;
each said receptacle further comprising a spill angle, a fill-line and a lead side, said lead side and said fill-line intersecting at an intersection point, each said receptacle further comprising a back side and a lip portion, said lip portion further comprising a back point, whereby said spill angle comprises the angle formed between a line projected horizontally across said fill-line from said intersection point toward said back side and a line projected from said intersection point toward said back point when said receptacle is in said resting position;
each said receptacle further comprising a lip angle, said lip angle is comprised of the angle from horizontal of a line projected from said lead point to said back point when said receptacle is in a resting position, said lip angle of said first receptacle being greater than or equal to its respective receptacle angle and said lip angle of said second receptacle being less than its respective receptacle angle;
whereby said first receptacle is fixated in mutual relationship with said second receptacle whereby, in said second receptacle, 90 degrees minus the receptacle angle is equal to or less than, in said first receptacle, the spill angle from horizontal plus the receptacle angle from vertical; and
whereby said second receptacle is fixated in mutual relationship with said first receptacle whereby, in said first receptacle, 90 degrees minus the receptacle angle is equal to or less than, in said second receptacle, two times the spill angle.

46. The device of claim 45, wherein said fill-line on at least one of said receptacles is a maximum fill-line.

47. The device of claim 46, wherein said fill-line on each of said two receptacles is a maximum fill-line.

48. The device of claim 47, wherein said maximum fill-line of said first receptacle is comprised of the level to which said first receptacle can be filled to a capacity where the resulting spill angle is the minimum angle that satisfies both (1) in said second receptacle, 90 degrees minus the receptacle angle is equal to or less than, in said first receptacle, the spill angle plus the receptacle angle and (2) is equal to or greater than the lip angle of said first receptacle, and wherein said maximum fill-line of said second receptacle is comprised of the level to which said second receptacle can be filled to a capacity where the resulting spill angle is the minimum angle that satisfies both (1) in said first receptacle, 90 degrees minus the receptacle angle is equal to or less than, in said second receptacle, two times the spill angle, and (2) is equal to or greater than the lip angle of said second receptacle.

49. The device of claim 45, wherein said device further comprises a liquid, said fill-line further comprising a horizontal liquid surface level.

50. The device of claim 45, wherein said fill-line further comprises indicia.

51. The device of claim 45, wherein said fill-line further comprises instructions.

52. The device of claim 45, wherein said lead side is generally straight.

53. The device of claim 45, wherein said lead side is generally concave.

54. The device of claim 45, wherein said device further comprises at least one stem, at least one said receptacle being attached to said device by said at least one stem.

55. The device of claim 54, wherein said at least one stem comprises a common stem.

56. The device of claim 54, wherein said at least one stem comprises two separate stems, one of said two receptacles being separately attached to said device by one of said two separate stems, and the other of said two receptacles being separately attached to said device by the other of said two separate stems.

57. The device of claim 54, wherein said at least one stem comprises further comprises two separate stems.

58. The device of claim 54, wherein said at least one stem has at least one stem angle, said stem angle being different than the receptacle angle of said at least one receptacle.

59. The device of claim 54, wherein said at least one stem has at least one stem angle, said stem angle being the same as the receptacle angle of said at least one receptacle.

60. The device of claim 45, wherein each of said two receptacles has an outside portion, each one of said two receptacles being attached to said other of said two receptacles at said outside portion.

61. The device of claim 45, wherein each of said receptacles is rotatable on a tilt plane, said tilt plane generally aligning with said lead point.

62. The device of claim 61, whereby said tilt plane for each of said receptacles is generally the same.

63. The device of claim 45, wherein said resting position further comprises a horizontal resting plane, the distance of said horizontal resting plane from said lead point on one of said two receptacles is different than the distance of said horizontal resting plane from said lead point on the other one of said two receptacles.

64. The device of claim 45, wherein said resting position further comprises a horizontal resting plane, the distance of said horizontal resting plane from said lead point on one of said two receptacles is generally the same as the distance of said horizontal resting plane from said lead point on the other one of said two receptacles.

65. The device of claim 45, wherein said device further comprises generally a block of at least one material, each of said two receptacles further embedded within said block.

66. The device of claim 45, at least one of said two receptacles having a back side, said back side having a reservoir.

67. A device for holding liquids for drinking by a user, said device comprising:
three receptacles, each said receptacle being non-contiguous with said other two receptacles;
each said receptacle having a receptacle angle, said receptacle angle being generally 45 degrees from vertical,
each said receptacle further having a lip portion, said lip portion having a lead point,
said device further having a resting position,
each said receptacle being affixed in mutual relationship with each other whereby when said device is in said resting position, when each said lead point is projected along a horizontal plane, each said projected lead point is generally 120 degrees from each said other projected lead point.

68. A device for holding liquids for drinking by a user, said device having at least one receptacle, said receptacle having at least one side portion, said at least one side portion having a reservoir area.

69. The device of claim 68, said at least one side portion further comprising a back side, said back side further comprising a concave portion.

70. The device of claim 69, said back side further having a top portion, said top portion having a back side, said top portion at said back side being closed.
